(19) United States
(12) Patent Application Publication
(10) Pub. No.: US 2026/0370790 A1
(43) Pub. Date: Nov. 19, 2026

(54) BEYOND-FIELD-OF-VIEW 3D STEREOSCOPIC DUAL-CAMERA TECHNICAL SYSTEM

(71) Applicant: Zhi ZHAO, Chengdu (CN)

(72) Inventor: Zhi ZHAO, Chengdu (CN)

(21) Appl. No.: 19/417,400

(22) Filed: Dec. 12, 2025

(30) Foreign Application Priority Data
May 19, 2025 (CN) 202510640213.9

(51) Int. Cl. H04N 13/239; H04N 13/00; H04N 13/296

(52) U.S. Cl. CPC H04N 13/239; H04N 13/296; H04N 2013/0074

(57) ABSTRACT

Disclosed is a beyond-field-of-view 3D stereoscopic dual-camera technical system (hereinafter referred to as “Beyond 3D”), belonging to the technical field of 3D stereoscopic dual-camera systems. Addressing the insufficient stereoscopic depth of traditional 3D dual cameras, as well as parallax distortion, brightness loss and dizziness caused by 2D-to-3D conversion, this solution achieves a field of view expansion of 20%-50% through coordinated displacement of dual cameras and post-processing parameter control, delivering a stereoscopic depth and spatial sense that is 2-3 times that of traditional systems and enabling highly immersive, distortion-free imaging. It is suitable for film and television production, VR, and other related fields.

### CROSS-REFERENCE TO RELATED APPLICATIONS

The application claims priority to Chinese patent application No. 202510640213.9, filed on May 19, 2025, the entire contents of which are incorporated herein by reference.

### TECHNICAL FIELD

The present disclosure is a collaborative system for displacement, rotation and post-processing parameter control of dual-camera units. Through a parallax enhancement algorithm and a parameter control system, the system breaks through a natural field of view of human eyes to achieve visual-tactile experience, which is immersive from watching a movie to touching movie frames. The system is applicable for scene construction of highly immersive 3D film and television production, VR, games, metaverse and related content.

### BACKGROUND

Traditional 3D dual cameras have three major pain points;
(1) Traditional 3D dual cameras have singular parameters, with a fixed pupil distance baseline of 6-6.5 cm, resulting in insufficient stereoscopic depth and spatial sense of depth of image effects.
(2) An image relies on a simulation technology of converting 2D to 3D, resulting in distortion of image parallax and brightness, severe loss of texture, and long-term watching can easily cause dizziness and fatigue.
(3) The lack of unified system technical standards has led to uneven quality of 3D-related content and a year-by-year decrease in market acceptance.

The beyond-field-of-view 3D stereoscopic dual-camera technical system (beyond 3D) of the present disclosure, will solve the above pain points. The beyond 3D has an extremely rigorous and unique dual-camera technology solution. Through combined operations of displacement, rotation, and post-processing of a 12-30 cm dual-camera unit baseline, the stereoscopic effect presented is 2-3 times that of the traditional dual-camera unit with a 6-6.5 cm baseline. The effect is significant in tests on a 150-inch large screen and in VR, making 3D video images groundbreaking visual experience that is within reach. The beyond 3D uses optical parameters with a focal length of no less than 50 mm, completely eliminating edge perspective distortion caused by stretching distortion of wide-angle lenses (24-35 mm) in traditional 3D, and suppresses dizziness from a physical level. Moreover, beyond 3D videos are not interconvertible with traditional 3D videos, and 2D videos cannot be converted to beyond 3D videos. Beyond 3D movies are compatible with traditional 3D theaters and can be watched without changing equipment. In the future, AI to beyond 3D conversion will be irreplaceable. Therefore, it is necessary to invent a more standardized 3D dual-camera technical system with a very strong visual immersive experience sense to ensure the authority of 3D films and related 3D content.

### SUMMARY

The present disclosure solves three major pain points of the traditional 3D dual-camera technology: an insufficient stereoscopic sense caused by adherence to a human eye interpupillary distance (approximately 6.5 cm), image distortion and watching dizziness caused by reliance on 2D to 3D conversion, and inconsistent 3D content quality due to the lack of unified standards.

The present disclosure aims to provide a brand-new dual-camera technical system solution that does not rely on physiological limits of the human eye. Through collaboration of dual-camera units at a physical level and precise compensation of a post-processing algorithm, the solution actively creates stereoscopic vision that surpasses a natural field of view of the human eye, thereby constructing a highly immersive, dizziness-free 3D content production system with unified technical standards.

The core of a beyond-field-of-view 3D stereoscopic dual-camera technical system lies in:
1. Dual-camera units with coordinated movement: The system sets a right camera unit to be fixed (17 in FIG. 2) as a spatial reference; a left camera unit can perform horizontal lateral displacement, expanding the baseline range to 12-30 cm (65 in FIG. 2), and can perform clockwise rotation from 1° to 3°. The rotation angle is precisely matched according to a shooting object distance (close, medium, and distance shots).
2. Beyond-field-of-view acquisition and algorithm compensation: The left camera unit achieves beyond-field-of-view acquisition through displacement. In post-processing, an image of the right camera unit (55 in FIG. 4) is used as the reference, and rightward percentage displacement is performed on an image of the left camera unit (56 in FIG. 4) (1-3% for a close shot, 3-5% for a medium shot, and 5-10% for a distant shot) to align an image subject to a natural focusing position (57 in FIG. 5) to form an enhanced stereoscopic parallax.
3. Forced optical parameter system: The system forces use of lenses with a focal length not less than 50 mm (62 and 63 in FIG. 2) and an aperture of f/4-5.0, fundamentally eliminating distortion of traditional wide-angle lenses (60 and 61 in FIG. 1) and ensuring image quality and watching comfort.

A qualitative leap in stereoscopic effects: Through large baseline displacement of 12-30 cm and post-processing parallax enhancement, the stereoscopic depth and spatial sense of depth presented are 2-3 times those of traditional dual cameras, achieving groundbreaking visual experience that is “within reach”.

Fundamental improvement of watching comfort: With the forced telephoto lens and optimized aperture, more than 70% of edge distortion is eliminated; post-processing precise displacement compensation controls a parallax error within a natural imaging zone of the human eye, effectively eliminating dizziness and fatigue.

Construction of an insurmountable technological barrier: The composite parameter system used in the present disclosure (such as 12-30 cm baseline, 1°-3° rotation, and forced focal length≥50 mm) is unique, making a generated beyond 3D video not interconvertible with a traditional 3D or 2D video. This establishes a technical standard from the source, ensuring the high quality and authority of 3D content.

### BRIEF DESCRIPTION OF DRAWINGS

FIG. 1: A schematic diagram of traditional 3D dual-camera units with a fixed simulated human eye baseline.

FIG. 2: A schematic diagram of displacement of a left camera unit of a beyond 3D dual-camera system.

FIG. 3: A schematic diagram illustrating a relationship between primary and secondary subjects in beyond 3D shooting.

FIG. 4: A schematic diagram of left and right eye images shot by beyond 3D dual-camera units.

FIG. 5: A schematic diagram of post-processing adjustment of beyond 3D.

FIG. 6: A schematic diagram illustrating post-processing focusing position adjustment of beyond 3D.

FIG. 7: A schematic diagram illustrating post-processing focusing position adjustment of beyond 3D.

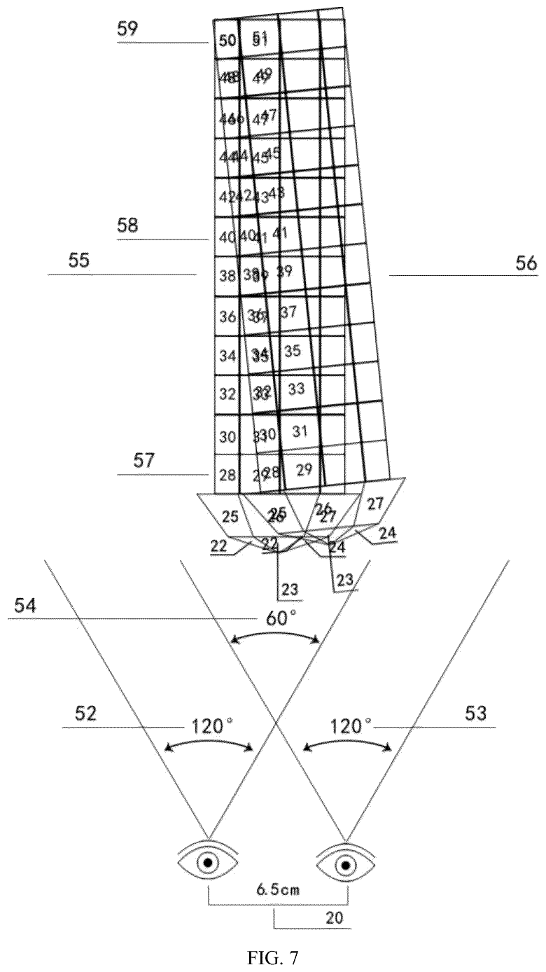

FIG. 8: A schematic diagram of displacement of a right camera unit of a beyond 3D dual-camera system.

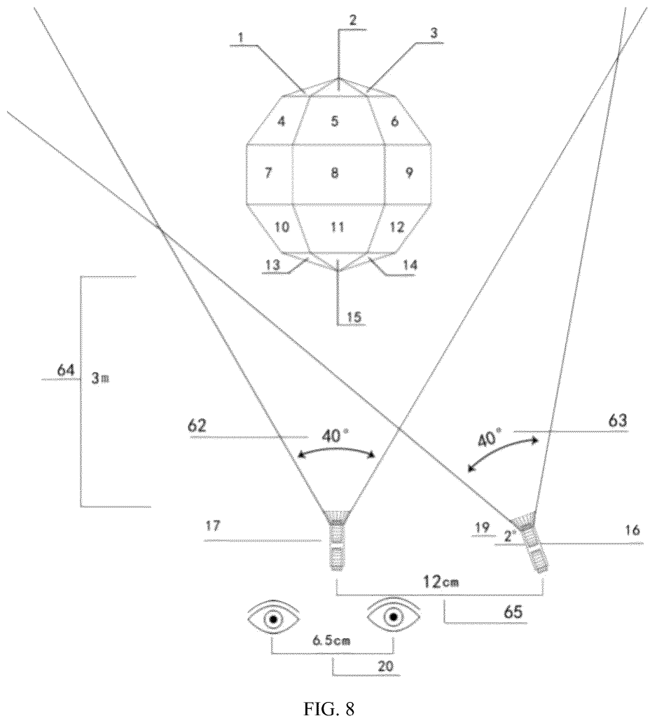

### DETAILED DESCRIPTION OF THE EMBODIMENTS

### (I) Technical Problems to be Solved

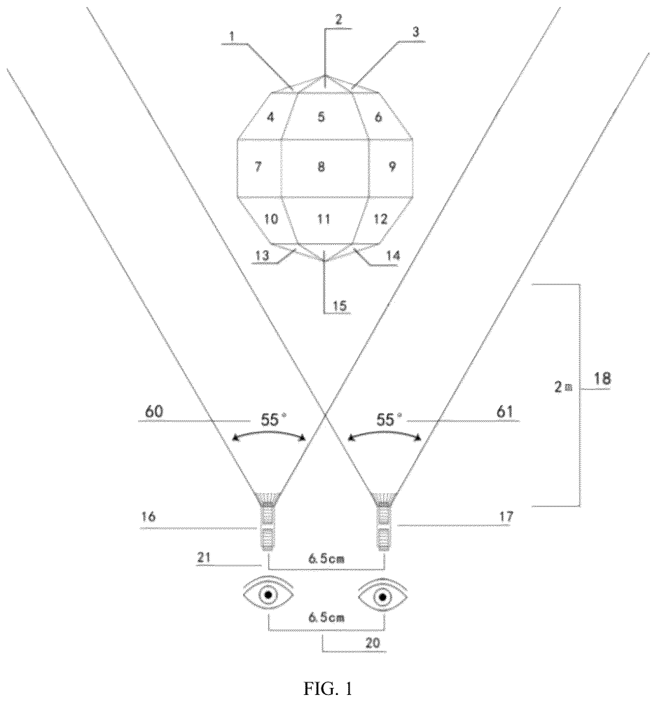

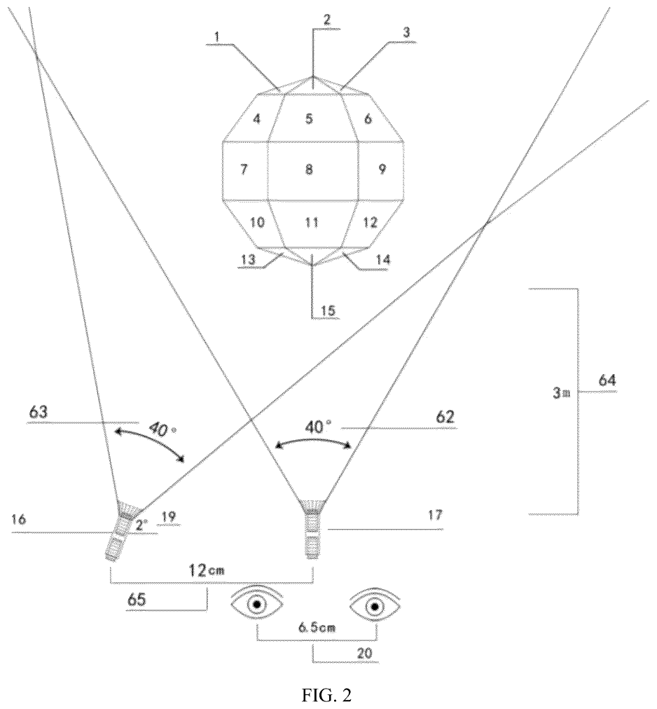

Problems to be solved: a fixed interpupillary distance (20 in FIG. 1) in traditional 3D dual cameras (as shown in FIG. 1), which leads to an insufficient stereoscopic depth, parallax brightness distortion and watching fatigue caused by reliance on the 2D to 3D conversion technology, and inconsistent content quality due to lack of unified technical standards. A beyond 3D technical system solution (as shown in FIG. 2) provides a beyond-field-of-view 3D stereoscopic dual-camera technology, which is achieved through unit displacement, precise optical parameter control and a post-processing parallax enhancement algorithm, breaking through limitations of a natural field of view of a human eye and constructing a highly immersive and dizziness-free 3D content production standard.

### (II) Technical Solution

Structured representation of a dual-camera unit collaboration module;
1. Right camera unit; a right eye angle of view reference is fixed (17 in FIG. 2) at the pupil center and is used to acquire images within a standard field of view range.
2. Left camera unit; horizontal lateral displacement (65 in FIG. 2) (displacement range of 12-30 cm, adjustable flexibly, offset to the left) and clockwise angle rotation (19 in FIG. 2), with an angle range of 1°-3°; the dual-camera units are fixed according to a subject object distance for each lens; and if subject movement is from far to near, medium-shot parameters are used fixedly:
   Close shot (2-3 m)≤1°;
   Medium shot (3-5 m)≤2°;
   Distant shot (5-20 m)≤3°.

Beyond-field-of-view acquisition design; the range of the left camera unit exceeds the natural field of view of the human eye by 20%-50%, covering a wider left-side field of view (as shown in FIG. 1). Traditional 3D dual-camera unit solutions can only shoot 10-15 surfaces, while the beyond 3D dual-camera solution in FIG. 2 can shoot 10~15+7 surfaces. The total content shot by the dual-camera units is more extensive and stereoscopic.

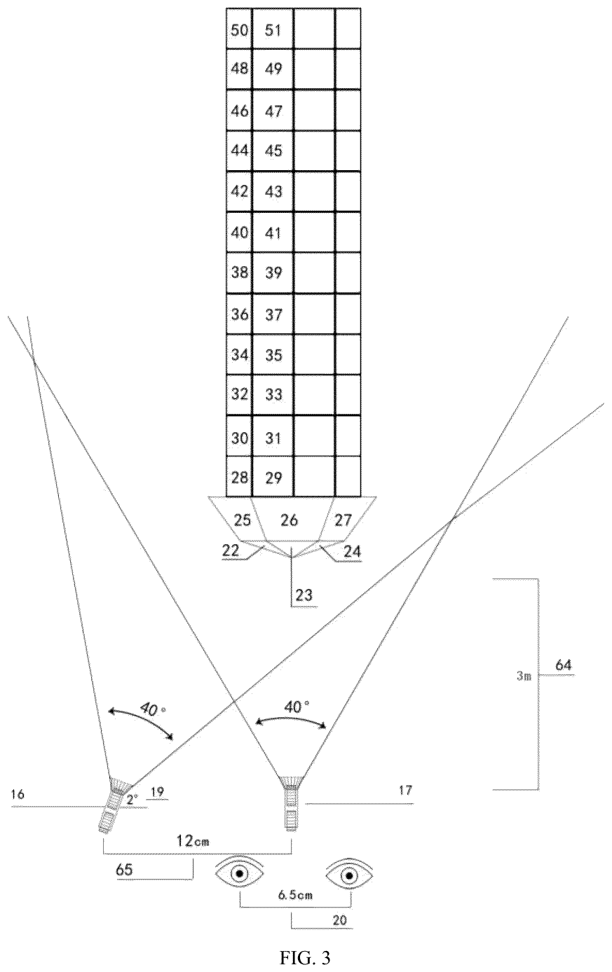

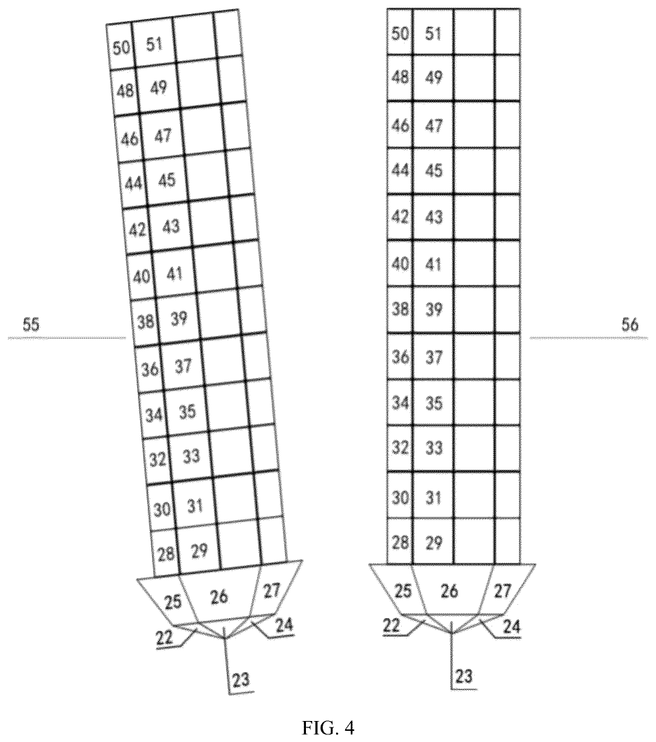

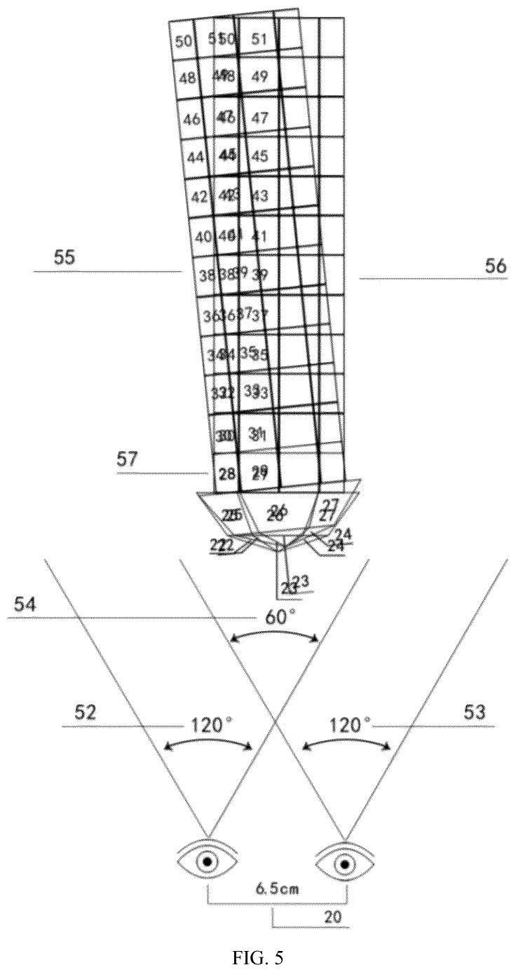

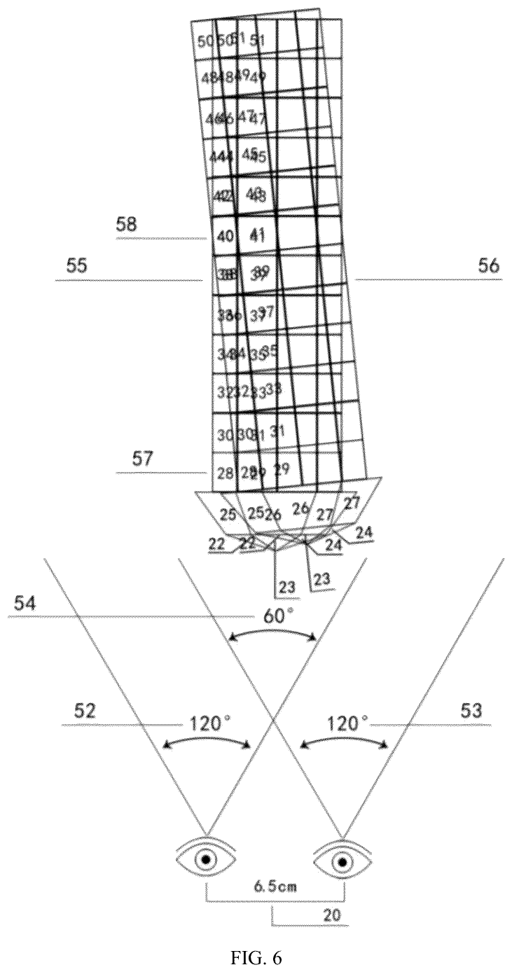

Post-compensation mechanism; taking the primary and secondary relationship in FIG. 3 as an example, 22-27 in FIG. 3 are primary subjects, and 28-51 in FIG. 3 are secondary subjects. The dual-camera units shoot an image based on the right unit (55 in FIG. 4), and the left camera unit shoots an image (56 in FIG. 4). The image of the left camera unit needs rightward displacement for focusing adjustment. The width of the image of the left camera unit needs displacement by a percentage according to the object distance. The rightward displacement with 1-3% for a close shot, 3-5% for a medium shot, and 5-10% for a distant shot aligns the image subject with the natural pupil focusing position, creating a beyond-field-of-view stereoscopic imaging parallax. Within the human monocular field of view (52, 53 in FIG. 5), the 120° natural eye field of view range, an optimal parallax range for focusing is formed (54 in FIG. 5); the optimal field of view for human stereoscopic imaging: (57 in FIG. 5) is a focusing position, (28 in FIG. 5) is a focusing point which is a horizontal line position of a visual screen and can perform displacement according to needs of subject visual expression (28-51 in 55, 56 in FIG. 4), the same digital focusing can be flexibly adjusted, (57 in FIG. 5) is a focusing position, (28 in FIG. 5) is a focusing point, (58 in FIG. 6) is a focusing site, and (40 in FIG. 6) is a focusing point.

The forced dual-camera focal length is ≥50 mm, (62, 63 in FIG. 2), the focal length is 50 mm; compared with the traditional focal length of 35 mm (60, 61 in FIG. 1), the image is fuller and there is no need to use a wide-angle lens to enhance the sense of depth, which can effectively avoid image stretching and distortion.

Matching rules for an optical parameter control system:
1. Basic optical parameter matching rules:
   Working focal length: ≥50 mm (forced 50-135 mm fixed-focus lens);
   Aperture value: f/4-5.0 (balancing depth of field and light intake to avoid image distortion and movement blur);
   Dual-camera subject object distance: min 2 m, max 20 m (ensuring a stereoscopic sense of depth within the depth of field range).
2. Subject object distance-focal length matching rules:
   Close shot (2-3 m): Focal length of 50-65 mm;
   Medium shot (3-5 m): Focal length of 50-85 mm;
   Distant shot (5-20 m): Focal length of 50-135 mm.

### Enhanced Core Performance and Three-Dimensional Perception

By fixing the right unit as the main baseline and performing left unit displacement (12-30 cm), the depth information of the shot image is increased, exceeding the natural field of view of the human eye by 20%-50% for beyond-field-of-view acquisition. Combined with post-processing offset adjustment of the parallax between the left and right eye images (the image rendering output needs to be 20% larger than the original size), a depth perception neural circuit of a visual cortex is activated, forming a “within reach” stereoscopic visual effect. The stereoscopic effect presented is 2-3 times that of the traditional dual-camera units with a baseline of 6-6.5 cm.

### Optimization of Watching Comfort

By forcing the focal length ≥50 mm (to avoid wide-angle distortion) and an aperture of f/4-5.0 (to balance the depth of field), edge stretching distortion is reduced by more than 70% from a physical perspective (compared to a traditional 35 mm lens), thus reducing the visual cortex processing load. After the left camera unit undergoes displacement of 12-30 cm and rotation of 1°-3°, the parallax error of the subject is controlled to ≤0.3 pixels (the human brain fusion comfort threshold is ≤0.5 pixels) through post-processing 1%-10% reverse displacement compensation. According to tests on 30 testees of different ages (18-65 years old, covering teenagers, young and middle-aged, and middle-aged and elderly), 97% of the testees were able to focus naturally on the first watching without any feedback of dizziness or eye fatigue. Typical test scenario parameter configuration: during shooting of a medium shot (object distance of 4 m), the left camera unit performs displacement by 18 cm and rotation by 2° with a focal length of 70 mm. In post-processing, 4% rightward displacement compensation was applied to achieve a parallax gradient of 1.0 (the optimal fusion gradient for the human brain is 0.8-1.2). This result verifies the technical logic of this solution, which controls the parallax within the natural processing range through parameter collaboration.

### Construction of Technical Barriers

A parallax parameter system of beyond 3D videos is completely independent of that of traditional 3D and 2D videos. The composite shooting technology principle of the dual-camera unit collaboration module baseline range (12-30 cm) and the left camera unit of 1°-3° and forced focal length ≥50 mm is the uniqueness of beyond 3D stereoscopic imaging, forming a technical characteristic of being not interconvertible with traditional 3D. Hence, the impact of traditional inferior 3D content and 2D to 3D conversion on content quality is eliminated from the source.

What is claimed is:

1. A beyond-field-of-view 3D stereoscopic dual-camera technical system, comprising a dual-camera unit collaboration module, an optical parameter control module, and a post-processing parallax adjustment module, wherein beyond-natural-field-of-view stereoscopic imaging is realized through baseline expansion and a parallax enhancement algorithm, specifically comprising:
the dual-camera unit collaboration module:
a first camera unit is fixed at a reference position, simulates a monocular perspective, and acquires images within a natural field of view range;
a second camera unit performs horizontal displacement and angle rotation through a composite movement mechanism;
a horizontal displacement range is 12-30 cm, and a displacement direction corresponds to the position of the first camera unit; if the first camera unit is a right camera unit, the second camera unit will perform leftward displacement; and if the first camera unit is a left camera unit, the second camera unit will perform rightward displacement;
an angle rotation range is 1°-3°, and a rotation direction matches the displacement direction; clockwise rotation is performed during the leftward displacement and counterclockwise rotation is performed during rightward displacement, a rotation angle being adjusted according to a subject object distance; the dual-camera units are fixed according to the subject object distance for each lens; and if subject movement is from far to near, medium-shot parameters are used fixedly:
2-3 m for a close shot, horizontal displacement of 12-15 cm and an angle ≤1°;
3-5 m for a medium shot, horizontal displacement of 15-20 cm and an angle ≤2°;
5-20 m for a distant shot, horizontal displacement of 20-30 cm and an angle ≤3°;
in post-processing, reverse displacement processing is performed on an image of the second camera unit, the displacement direction is opposite to that of the second camera unit; the displacement range is 1-3% for the close shot, 3-5% for the medium shot, and 5-10% for the distant shot; and an image subject is aligned with a natural human eye pupil focusing position;
the optical parameter control module:
a working focal length is ≥50 mm, a 50-135 mm fixed-focus lens is used, and the focal length is controlled according to the subject object distance:
2-3 m for a close shot, focal length: 50-65 mm;
3-5 m for a medium shot, focal length: 50-85 mm;
5-20 m for a distant shot, focal length: 50-135 mm;
an aperture value is f4-f5, and a dual-camera subject object distance range is 2-20 m;
the post-processing parallax adjustment module:
based on displacement parameters of the second camera unit, proportional reverse displacement processing is performed on the image thereof to create a beyond-field-of-view stereoscopic parallax effect.
